(19) United States
(12) Patent Application Publication
(10) Pub. No.: US 2026/0111679 A1
(43) Pub. Date: Apr. 23, 2026

(54) HALLUCINATION DETECTION SYSTEM, HALLUCINATION DETECTION METHOD, AND ELECTRONIC DEVICE

(71) Applicant: INSTITUTE FOR INFORMATION INDUSTRY, TAIPEI CITY (TW)

(72) Inventors: Zi-Ying Chen, Taipei (TW); Yu-Chuan YANG, Taipei (TW); Ping-I Chen, Taipei City (TW)

(21) Appl. No.: 18/959,776

(22) Filed: Nov. 26, 2024

(30) Foreign Application Priority Data
Oct. 17, 2024 (TW) 113139445

(51) Int. Cl. G06F 40/35

(52) U.S. Cl. CPC G06F 40/35

(57) ABSTRACT

An electronic device comprises a hallucination detection system. The hallucination detection system can execute a hallucination detection method. The hallucination detection method comprises implementing a conversion step, an authenticity detection step, and a result output step. The conversion step comprises: generating a plurality of output wordnets according to the output text. The authenticity detection step comprises: generating multiple pieces of authenticity information by a trained graph embedding model. Each of the multiple pieces of the authenticity information indicates whether one of the output wordnets is determined to be non-hallucinated or hallucinated by the graph embedding model. The result output step comprises: generating result of hallucination detection according to the multiple pieces of the authenticity information. The graph embedding model is trained through a plurality of positive wordnets and a plurality of negative wordnets generated from domain knowledge data.

### CROSS-REFERENCE TO RELATED PATENT APPLICATION

This application claims the benefit of priority to Taiwan Patent Application No. 113139445, filed on Oct. 17, 2024. The entire content of the above identified application is incorporated herein by reference.

Some references, which may include patents, patent applications and various publications, may be cited and discussed in the description of this disclosure. The citation and/or discussion of such references is provided merely to clarify the description of the present disclosure and is not an admission that any such reference is “prior art” to the disclosure described herein. All references cited and discussed in this specification are incorporated herein by reference in their entireties and to the same extent as if each reference was individually incorporated by reference.

### FIELD OF THE DISCLOSURE

The present disclosure relates to a hallucination detection system, a hallucination detection method, and an electronic device, and more particularly to a hallucination detection system and a hallucination detection method for detecting an output text generated by a large language model, and an electronic device that includes the hallucination detection system.

### BACKGROUND OF THE DISCLOSURE

A conventional large language model (LLM) uses a significant amount of words and texts for training. However, answers generated by the large language model and based on questions entered by users may easily contain incorrect information. When the users ask questions that are outside their expertise, it is difficult for the users to determine whether or not the answers from the large language model contain erroneous information (which is commonly referred to as hallucinations in the relevant industry), thereby causing use inconvenience to the users.

### SUMMARY OF THE DISCLOSURE

In response to the above-referenced technical inadequacy, the present disclosure provides a hallucination detection system, a hallucination detection method, and an electronic device, which are mainly used for hallucination detection on an output text generated by a large language model.

In order to solve the above-mentioned problem, one of the technical aspects adopted by the present disclosure is to provide a hallucination detection system. The hallucination detection system comprises a storage and a processor. The storage is configured to store an output text of a large language model. The processor is coupled to the storage. The processor is configured to execute a hallucination detection method after receiving the output text. The method comprises implementing a conversion step, an authenticity detection step, and a result output step. The conversion step comprises: generating a plurality of output wordnets according to the output text. The authenticity detection step comprises: generating multiple pieces of authenticity information by a trained graph embedding model. Each of the multiple pieces of the authenticity information indicates whether each of the output wordnets is determined to be non-hallucinated or hallucinated by the graph embedding model. The result output step comprises: generating the result of hallucination detection according to the multiple pieces of the authenticity information. The result of hallucination detection includes at least one of whether or not the output text has hallucinations, a hallucination ratio of the output text, and the output wordnets determined to be hallucinated present in the output text. The graph embedding model is trained through a plurality of positive wordnets and a plurality of negative wordnets generated from domain knowledge data.

In order to solve the above-mentioned problem, another one of the technical aspects adopted by the present disclosure is to provide an electronic device. The electronic device comprises the above-mentioned hallucination detection system and a monitor. The processor is electrically connected to the monitor, and the processor is configured to control the monitor to display the result of hallucination detection.

In order to solve the above-mentioned problem, yet another one of the technical aspects adopted by the present disclosure is to provide a hallucination detection method. The hallucination detection method is used for performing hallucination detection on an output text of a large language model and generating result of hallucination detection, and is executed by a processor. The method comprises implementing a conversion step, an authenticity detection step, and a result output step. The conversion step comprises: generating a plurality of output wordnets according to the output text. The authenticity detection step comprises: generating multiple pieces of authenticity information by a trained graph embedding model. Each of the multiple pieces of the authenticity information indicates whether one of the output wordnets is determined to be non-hallucinated or hallucinated by the graph embedding model. The result output step comprises: generating the result of hallucination detection according to the multiple pieces of the authenticity information. The result of hallucination detection includes at least one of whether or not the output text has hallucinations, a hallucination ratio of the output text, and the output wordnets determined to be hallucinated present in the output text. The graph embedding model is trained through a plurality of positive wordnets and a plurality of negative wordnets generated from domain knowledge data.

Therefore, in the hallucination detection system, the hallucination detection method, and the electronic device provided by the present disclosure, by virtue of the conversion step, the authenticity detection step, and the result output step, users can view the result of hallucination detection to know whether or not the output text generated by the large language model has hallucinations, a hallucination ratio of the output text, and the output wordnets determined to be hallucinated present in the output text.

These and other aspects of the present disclosure will become apparent from the following description of the embodiment taken in conjunction with the following drawings and their captions, although variations and modifications therein may be affected without departing from the spirit and scope of the novel concepts of the disclosure.

### BRIEF DESCRIPTION OF THE DRAWINGS

The described embodiments may be better understood by reference to the following description and the accompanying drawings, in which:

FIG. 1 is a circuit block diagram of a hallucination detection system according to the present disclosure;

FIG. 2 is a flowchart of a hallucination detection method according to the present disclosure; and FIG. 3 is a schematic view of an electronic device according to the present disclosure.

### DETAILED DESCRIPTION OF THE EXEMPLARY EMBODIMENTS

The present disclosure is more particularly described in the following examples that are intended as illustrative only since numerous modifications and variations therein will be apparent to those skilled in the art. Like numbers in the drawings indicate like components throughout the views. As used in the description herein and throughout the claims that follow, unless the context clearly dictates otherwise, the meaning of “a,” “an” and “the” includes plural reference, and the meaning of “in” includes “in” and “on.” Titles or subtitles can be used herein for the convenience of a reader, which shall have no influence on the scope of the present disclosure.

The terms used herein generally have their ordinary meanings in the art. In the case of conflict, the present document, including any definitions given herein, will prevail. The same thing can be expressed in more than one way. Alternative language and synonyms can be used for any term(s) discussed herein, and no special significance is to be placed upon whether a term is elaborated or discussed herein. A recital of one or more synonyms does not exclude the use of other synonyms. The use of examples anywhere in this specification including examples of any terms is illustrative only, and in no way limits the scope and meaning of the present disclosure or of any exemplified term. Likewise, the present disclosure is not limited to various embodiments given herein. Numbering terms such as “first,” “second” or “third” can be used to describe various components, signals or the like, which are for distinguishing one component/signal from another one only, and are not intended to, nor should be construed to impose any substantive limitations on the components, signals or the like.

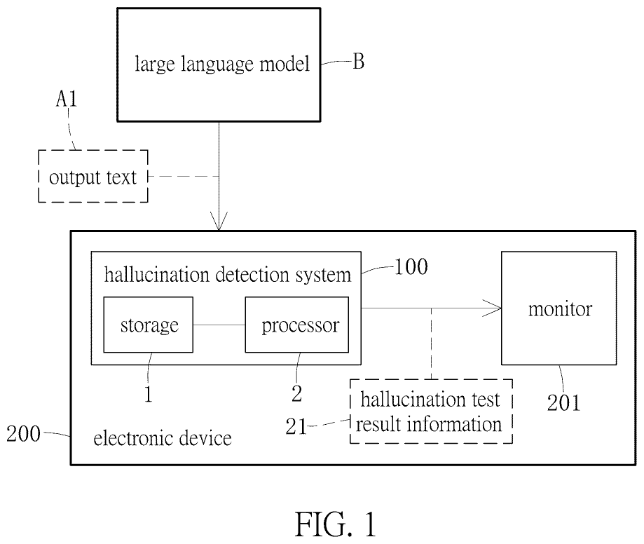

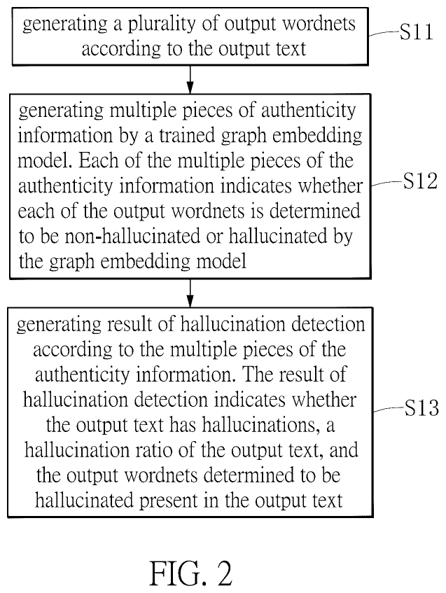

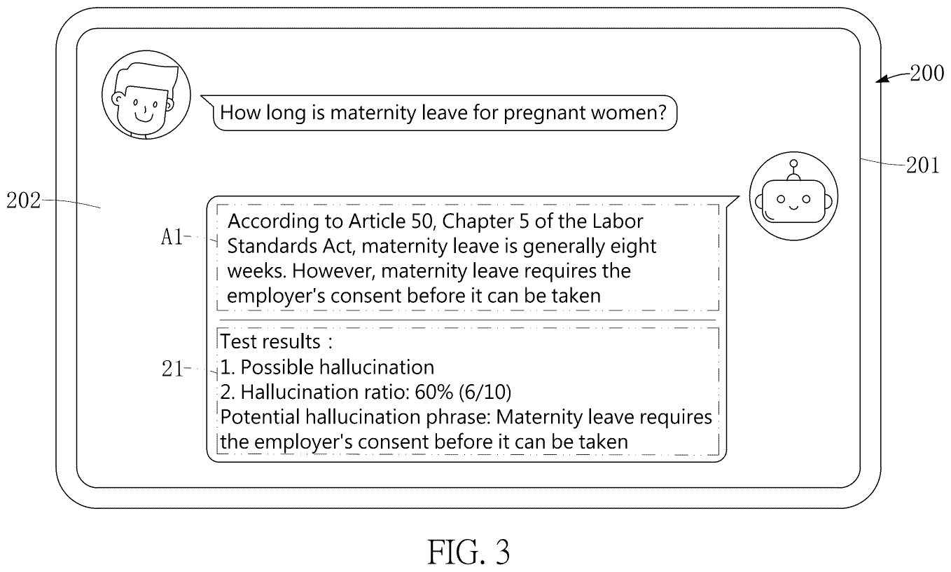

Referring to FIG. 1 to FIG. 3, FIG. 1 is a circuit block diagram of a hallucination detection system according to the present disclosure, FIG. 2 is a flowchart of a hallucination detection method according to the present disclosure, and FIG. 3 is a schematic view of an electronic device according to the present disclosure.

A hallucination detection system 100 of the present disclosure includes a storage 1 and a processor 2. The hallucination detection system 100 of the present disclosure can be constructed in an electronic device 200 of the present disclosure. The electronic device 200 can be exemplified to be a server, a computer (e.g., a home computer or an industrial computer), or a portable electronic product (e.g., a laptop, a smart phone, or a tablet computer). In practical applications, the electronic device 200 can, for example, be built with a large language model (LLM) and application programs thereof.

The storage 1 is used to store an output text A1 of a large language model B. The storage 1 is primarily used to store the output text A1. In practice, the type and the form of the storage 1 can be chosen based on requirements, and are not limited in the present disclosure. For example, the storage 1 can be various types of memory, hard disk, etc. In different embodiments, the storage 1 and the processor 2 may be integrated into a processing module, and the storage 1 is configured as a memory unit in the processing module.

The processor 2 is coupled to the storage 1. The processor 2 can obtain the output text A1 generated by the large language model B and store the output text A1 in the storage 1. In practice, the processor 2 can, for example, use an application programming interface (API) to obtain the output text A1 generated by the large language model B and store the output text A1 in the storage 1.

After the processor 2 receives the output text A1, the processor 2 can execute the hallucination detection method of the present disclosure, which includes implementing a conversion step S11, an authenticity detection step S12, and a result output step S13.

The conversion step S11 includes: generating a plurality of output wordnets according to the output text A1.

The authenticity detection step S12 includes: generating multiple pieces of authenticity information by a trained graph embedding model. Each of the multiple pieces of the authenticity information indicates whether each of the output wordnets is determined to be non-hallucinated or hallucinated by the graph embedding model.

The result output step S13 includes: generating result of hallucination detection 21 according to the multiple pieces of the authenticity information.

The result of hallucination detection 21 indicates whether the output text A1 has hallucinations, a hallucination ratio of the output text A1, and the output wordnets determined to be hallucinated present in the output text A1.

The graph embedding model is trained through a plurality of positive wordnets and a plurality of negative wordnets generated from domain knowledge data. The scope of the domain knowledge data can be chosen based on practical requirements. For example, the scope of the domain knowledge data can be the legal field or the Labor Standards Act, but the present disclosure is not limited thereto.

In practice, before training the graph embedding model, each of the positive wordnets and each of the negative wordnets are added with non-hallucinated labels and hallucinated labels. Afterwards, the graph embedding model can be trained by using the graph neural network (GNN) technology. Accordingly, the graph embedding model can learn a plurality of language characteristics of each of a plurality of roots within the wordnet and a plurality of network structural characteristics between the roots. Moreover, the graph embedding model can also learn which combinations of characteristics are non-hallucinated and which combinations of characteristics are hallucinated.

In the hallucination detection system provided by the present disclosure, the output text A1 output by the large language model B is converted into the output wordnets, and then each of the output wordnets is determined to be non-hallucinated or hallucinated by the trained graph embedding model, so that the result of hallucination detection 21 is generated, and a user can determine whether or not the output text A1 generated by the large language model B has hallucinations (i.e., whether the output text A1 contains any hallucinated words or hallucinated sentences) within a specific domain knowledge data (i.e., the domain knowledge data that is used to train the graph embedding model).

In one embodiment, when the processor 2 in the authenticity detection step S12 determines that any one of the output wordnets is hallucinated by the graph embedding model, the result of hallucination detection 21 generated by the processor 2 in the result output step S13 indicates that the output text A1 has hallucinations.

For example, as shown in FIG. 3, the electronic device 200 is assumed to be running an application 202 similar to ChatGPT®. While the user inputs the question “How long is maternity leave for pregnant women?”, the output text generated by the large language model B is “According to Article 50, Chapter 5 of the Labor Standards Act, maternity leave is generally eight weeks. However, maternity leave requires the employer's consent before it can be taken.” After the processor 2 completes the conversion step S11, the authenticity detection step S12, and the result output step S13, the processor 2 will control a monitor 201 to display the result of hallucination detection 21. The user will then see texts such as “Possible hallucination”on an interface of the application 202.

The hallucination ratio can be generated based on a total number of non-hallucinated outputs and a total number of hallucinated outputs. The total number of non-hallucinated outputs refers to a quantity of the output wordnets determined to be non-hallucinated by a graph embedding model A. The total number of hallucinated outputs refers to a quantity of output wordnets from the output text A1 determined to be hallucinated by the graph embedding model A. For example, if the output text A1 is converted into ten output wordnets, and four of the ten output wordnets are determined to be non-hallucinated and six of the ten output wordnets are determined to be hallucinated by the processor 2 in the authenticity detection step S12, the hallucination ratio of the result of hallucination detection 21 generated by the processor 2 in the result output step S13 will be 60%. As shown in FIG. 3, the result of hallucination detection 21 that the user sees on the monitor 201 of the electronic device 200 can be exemplified to include texts such as “hallucination ratio: 60%.” In one embodiment, the result of hallucination detection 21 includes the hallucination vocabulary, and the hallucination vocabulary refers to a root word in the output wordnets in the output wordnets determined to be hallucinated by the graph embedding model A. In another embodiment, the result of hallucination detection 21 may be a sentence that includes the hallucination vocabulary. For example, the graph embedding model is assumed to be trained by using the positive wordnets and the negative wordnets based on the “Labor Standards Act,” and the output text A1 from the large language model B is: “According to Article 50, Chapter 5 of the Labor Standards Act, maternity leave is generally eight weeks. However, maternity leave requires the employer's consent before it can be taken.” If the graph embedding model determines that the output wordnet “maternity leave requires employer consent can be taken” is hallucinated, then the root words in the output wordnets contained in the output wordnets, such as “maternity leave,” will be classified as the hallucination vocabulary. In the result of hallucination detection 21, the user will be alerted that the sentence corresponding to the output wordnets (i.e., “maternity leave requires the employer's consent before it can be taken”) and all the words within the output wordnet (i.e., maternity leave, requires, employer, consent, can, be taken) may have hallucinations. As shown in FIG. 3, from the result of hallucination detection 21 on the electronic device 200, the user can see texts such as “Potential hallucination phrase: Maternity leave requires the employer's consent before it can be taken.”

It should be noted that FIG. 3 is an example where the result of hallucination detection 21 includes three detection results, which are: whether or not there is hallucination, the hallucination ratio, and the hallucination vocabulary. However, the result of hallucination detection 21 is not limited to containing all three detection results at the same time. In different embodiments, the result of hallucination detection 21 may include only one of the three detection results or any two of the three detection results.

In practical applications, in the conversion step S11, the output text A1 can first be processed by applying at least one of sentence segmentation, word segmentation, removal of words with specific parts of speech, and removal of specific symbols for generation of a plurality of output words. Then, these output words are input into a trained language feature model to generate the output wordnets. A method for generating the output wordnets can be designed based on practical requirements, and is not limited thereto. For example, in one embodiment, the output wordnets can be generated by using each of the sentences from the output text A1. In another embodiment, the output wordnets can be generated by using various words from the output text A1. In yet another embodiment, the output wordnets can be generated by using different paragraphs from the output text A1. The methods described in the above-mentioned three embodiments can also coexist within a single embodiment. Any two of the three embodiments can also be combined to form a new embodiment.

The purpose of removing words with specific parts of speech is primarily to eliminate meaningless words, such as particles and interjections, while retaining meaningful words, such as subjects, verbs, nouns, and adjectives. A method for determining a part of speech of each word is well-known in the field and will not be elaborated herein. The purpose of removing the specific symbols is mainly to eliminate meaningless symbols, such as line breaks, spaces, exclamation marks, and so on.

In actual applications, the processor 2 can perform the following steps to train the language feature model. A domain word generation step includes: performing at least one of sentence segmentation, word segmentation, removal of words with specific parts of speech, and removal of specific symbols on the domain-specific knowledge texts, so as to generate a plurality of sequential domain terms. A model training step includes: inputting the sequential domain terms into a Word2Vec model to train the language feature model.

The domain-specific knowledge texts refer to texts generated from domain knowledge data. For example, if the domain knowledge data is the “Labor Standards Act,” each of the domain-specific knowledge texts may be individual articles or clauses from the Labor Standards Act.

After the language feature model is trained through the above steps, a correspondence relationship between words and vectors within the domain knowledge data can be obtained. Furthermore, the relevance between specific words and words within the domain knowledge data can be determined. For example, if the language feature model is trained by using the “Labor Standards Act,” inputting the words “maternity leave” into the language feature model can result in obtaining words that are closely associated with “maternity leave” within the context of the “Labor Standards Act.” Similarly, the language feature model can also be used to identify words that have low relevance with “maternity leave” within the context of the “Labor Standards Act.”

As described above, in the conversion step S11, a punctuation mark “period” can, for example, first be used to segment the output text A1 into sentences. Then, techniques such as Jieba or spaCy can be used to perform word segmentation on each of the sentences. In practical applications, when performing word segmentation on each of the sentences, techniques such as Jieba or spaCy can be used in conjunction with pre-stored domain-specific lexicons and dictionaries. In this way, each of the sentences is subjected to more accurate word segmentation.

By first segmenting the output text A1 into sentences and then performing word segmentation on each of the sentences, the output words will maintain an inherent sequential order. For example, the output text is “According to Article 50, Chapter 5 of the Labor Standards Act, maternity leave is generally eight weeks. However, maternity leave requires the employer's consent before it can be taken.” After sentence segmentation, two resulting sentences are: “According to Article 50, Chapter 5 of the Labor Standards Act, maternity leave is generally eight weeks” and “However, maternity leave requires the employer's consent before it can be taken.” After word segmentation of the first sentence, the output words can be, for example, “Labor Standards Act,” “Chapter 5,” “Article 50,” “provisions,” “maternity leave,” “in principle,” “has,” and “eight weeks,” thereby resulting in a total of eight output words. Since the eight output words come from the same sentence, the eight output words maintain a sequential order during program processing and can be stored in formats that represent such a sequence (such as arrays or dictionaries).

As described above, by processing the output text through sentence segmentation and word segmentation, sequential output words can be generated. The language feature model is capable of representing the corresponding vectors for each of the words within the domain knowledge data. Therefore, by inputting the sequential output words into the language feature model, the output wordnets can be obtained.

In continuation of the previous example, after the first sentence is segmented into eight output words, these eight sequential output words are input into the trained language feature model. As a result, the output wordnets corresponding to the first sentence, such as “Labor Standards Act, Chapter 5, Article 50, provisions, maternity leave,” “Chapter 5, Article 50, provisions, maternity leave, in principle,” “maternity leave, in principle, has eight weeks,”and so on, can be obtained.

By using the domain-specific knowledge texts from the domain knowledge data to train the language feature model, the positive wordnets and the negative wordnets within the domain knowledge data can be established. Specifically, before the processor 2 implements the authenticity detection step S12, the processor 2 first performs a positive training data generation step and a negative training data generation step. The positive training data generation step includes: inputting the domain-specific knowledge texts into the language feature model to generate the positive wordnets. The negative training data generation step includes: using the language feature model to generate the negative wordnets by replacing the root word in the output wordnets in each of the positive wordnets with a low-relevance word.

As previously described, the language feature model trained with domain knowledge data can represent the relevance between various domain terms within that domain. Hence, after establishing the positive wordnets, the language feature model can be used to identify low-relevance words by finding words having large vector distances with the root words in the output wordnets of each of the positive wordnets. In this way, the negative wordnets can be constructed by using each low-relevance word and the positive wordnets. Specifically, since the language feature model projects each of the words onto a vector, the cosine similarity can be used to calculate a distance between two vectors, so as to determine the relevance between two words.

It should be noted that, since the establishing process of the positive wordnets and the negative wordnets can be fully automated by use of a program (without any human intervention), both time and labor costs can be significantly saved.

If a knowledge graph is used to create positive and negative training data for training the language feature model, relationships between each word in the text or sentence need to be manually annotated (which requires great manpower and wastes a large amount of time) at an initial phase of building the knowledge graph, so as to establish the relevance between the words in the knowledge graph. The personnel responsible for annotation must possess the domain-specific knowledge, especially a clear understanding of the non-hallucinated meaning of the annotated content, so that the relationships between the words in the text are accurately annotated. In other words, if a language feature model is being trained based on the “Labor Standards Act”, and the knowledge graph is used to create the positive and negative training data, the annotators must be familiar with the specific articles and specialized terms of the Labor Standards Act, so as to accurately annotate the relationships between the words in each article of the law.

For example, when manually annotating the provision from Article 50 of Chapter 5 in the subsidiary regulations of the Labor Standards Act, which states that “Female workers shall cease work before and after childbirth and be granted eight weeks of maternity leave,” the relevant personnel must annotate “Labor Standards Act” as “law,” “Chapter 5” as “subsidiary regulation,” and “Article 50” as “sub-subsidiary regulation.” In addition, the relationships between “Labor Standards Act,” “Chapter 5,” and “Article 50” are annotated as follows: “Labor Standards Act” includes “Chapter 5,” “Chapter 5” belongs to the “Labor Standards Act,” “Chapter 5” includes “Article 50,” and “Article 50” belongs to “Chapter 5.” Furthermore, it is essential to annotate that “rights” is a protection item, “female workers” are protected subjects, and the relationships between “Article 50,” “rights,” and “female workers” are annotated as follows: “Article 50” includes “rights” and “female workers,” “rights” belongs to “Article 50,” and “female workers” belong to “Article 50.”

In conclusion, in the hallucination detection system, the hallucination detection method, and the electronic device provided by the present disclosure, by virtue of the conversion step, the authenticity detection step, and the result output step, users can view the result of hallucination detection to know whether or not the output text generated by the large language model has hallucinations, a hallucination ratio of the output text, and the output wordnets determined to be hallucinated present in the output text.

The foregoing description of the exemplary embodiments of the disclosure has been presented only for the purposes of illustration and description and is not intended to be exhaustive or to limit the disclosure to the precise forms disclosed. Many modifications and variations are possible in light of the above teaching.

The embodiments were chosen and described in order to explain the principles of the disclosure and their practical application so as to enable others skilled in the art to utilize the disclosure and various embodiments and with various modifications as are suited to the particular use contemplated. Alternative embodiments will become apparent to those skilled in the art to which the present disclosure pertains without departing from its spirit and scope.

What is claimed is:

1. A hallucination detection system, comprising:
a storage configured to store an output text of a large language model; and
a processor coupled to the storage, wherein the processor is configured to execute a hallucination detection method after receiving the output text, and the hallucination detection method comprises:
implementing a conversion step which comprises: generating a plurality of output wordnets according to the output text;
implementing an authenticity detection step which comprises: generating multiple pieces of authenticity information for each of the output wordnets by a trained graph embedding model, wherein each of the multiple pieces of the authenticity information indicates whether each of the output wordnets is determined to be non-hallucinated or hallucinated by the graph embedding model; and
implementing a result output step which comprises: generating result of hallucination detection according to the multiple pieces of the authenticity information, wherein the result of hallucination detection includes at least one of whether or not the output text has hallucinations, a hallucination ratio of the output text, and the output wordnets determined to be hallucinated present in the output text;
wherein the graph embedding model is trained through a plurality of positive wordnets and a plurality of negative wordnets generated from domain knowledge data.

2. The hallucination detection system according to claim 1, wherein, when the processor determines in the authenticity detection step that any one of the output wordnets is hallucinated by the graph embedding model, the result of hallucination detection generated by the processor in the result output step indicates that the output text has the hallucinations.

3. The hallucination detection system according to claim 1, wherein the hallucination ratio is generated based on a total number of non-hallucinated outputs and a total number of hallucinated outputs, the total number of the non-hallucinated outputs refers to a quantity of the output wordnets determined to be non-hallucinated by the graph embedding model, and the total number of the hallucinated outputs refers to a quantity of the output wordnets determined to be hallucinated by the graph embedding model.

4. The hallucination detection system according to claim 1, wherein the hallucination vocabulary refers to a root word in the output wordnets in the output wordnets determined to be hallucinated by the graph embedding model.

5. The hallucination detection system according to claim 1, wherein, before implementation of the authenticity detection step, the processor first implements:
a positive training data generation step which comprises: inputting a plurality of domain-specific knowledge texts into a language feature model to generate the positive wordnets; and
a negative training data generation step which comprises: using the language feature model to generate the negative wordnets by replacing a root word in each of the positive wordnets with a low-relevance word.

6. The hallucination detection system according to claim 5, wherein, before
the positive training data generation step, the hallucination detection method further comprises:
implementing a domain word generation step which comprises: performing at least one of sentence segmentation, word segmentation, removal of words with specific parts of speech, and removal of specific symbols on the domain-specific knowledge texts, so as to generate a plurality of domain terms; and
implementing a model training step which comprises: inputting the domain terms into a Word2Vec model to train the language feature model.

7. The hallucination detection system according to claim 5, wherein, in the conversion step, the output text is processed by applying at least one of sentence segmentation, word segmentation, removal of words with specific parts of speech, and removal of specific symbols for generation of a plurality of output words, and the output words are input into the language feature model to create the output wordnets.

8. An electronic device, comprising the hallucination detection system as claimed in claim 1 and a monitor, wherein the processor is electrically connected to the monitor, and the processor is configured to control the monitor to display the result of hallucination detection.

9. A hallucination detection method, which is used for performing hallucination detection on an output text of a large language model and generating result of hallucination detection, and is executed by a processor, the hallucination detection method comprising:
implementing a conversion step which comprises: generating a plurality of output wordnets according to the output text;
implementing an authenticity detection step which comprises: generating multiple pieces of authenticity information by a trained graph embedding model, wherein each of the multiple pieces of the authenticity information indicates whether one of the output wordnets is determined to be non-hallucinated or hallucinated by the graph embedding model; and
implementing a result output step which comprises: generating the result of hallucination detection according to the multiple pieces of the authenticity information, wherein the result of hallucination detection includes at least one of whether or not the output text has hallucinations, a hallucination ratio of the output text, and the output wordnets determined to be hallucinated present in the output text;
wherein the graph embedding model is trained through a plurality of positive wordnets and a plurality of negative wordnets generated from domain knowledge data.

10. The hallucination detection method according to claim 9, wherein, when the processor determines in the authenticity detection step that any one of the output wordnets is hallucinated by the graph embedding model, the result of hallucination detection generated by the processor in the result output step indicates that the output text has the hallucinations.

11. The hallucination detection method according to claim 9, wherein the hallucination ratio is generated based on a total number of non-hallucinated outputs and a total number of hallucinated outputs, the total number of the non-hallucinated outputs refers to a quantity of the output wordnets determined to be non-hallucinated by the graph embedding model, and the total number of the hallucinated outputs refers to a quantity of the output wordnets determined to be hallucinated by the graph embedding model.

12. The hallucination detection method according to claim 9, wherein the hallucination vocabulary refers to a root word in the output wordnets in the output wordnets determined to be hallucinated by the graph embedding model.

13. The hallucination detection method according to claim 9, wherein, before the authenticity detection step, the hallucination detection method further comprises:
implementing a positive training data generation step which comprises: inputting a plurality of domain-specific knowledge texts into a language feature model to generate the positive wordnets;
implementing a negative training data generation step which comprises: using the language feature model to generate the negative wordnets by replacing the root word in the output wordnets in each of the positive wordnets with a low-relevance word.

14. The hallucination detection method according to claim 13, wherein, before the positive training data generation step, the hallucination detection method further comprises:
implementing a domain word generation step which comprises: performing at least one of sentence segmentation, word segmentation, removal of words with specific parts of speech, and removal of specific symbols on the domain-specific knowledge texts, so as to generate a plurality of domain terms; and
implementing a model training step which comprises: inputting the domain terms into a Word2Vec model to train the language feature model.

15. The hallucination detection method according to claim 13, wherein, in the conversion step, the output text is processed by applying at least one of sentence segmentation, word segmentation, removal of words with specific parts of speech, and removal of specific symbols for generation of a plurality of output words, and the output words are input into the language feature model to create the output wordnets.
